(19) United States
(12) Patent Application Publication
(10) Pub. No.: US 2011/0041644 A1
(43) Pub. Date: Feb. 24, 2011

(54) APPARATUS FOR REDUCING NOISE OF SHIFT CABLE

(75) Inventors: Jeehyuck Choi, Hwaseong-si (KR); Yangrae Cho, Gyeonggi-do (KR)

Correspondence Address: MORGAN, LEWIS & BOCKIUS LLP (SF), One Market, Spear Street Tower, Suite 2800, San Francisco, CA, 94105, US

(73) Assignee: HYUNDAI MOTOR COMPANY, Seoul (KR)

(21) Appl. No.: 12/619,148

(22) Filed: Nov. 16, 2009

(30) Foreign Application Priority Data
Aug. 18, 2009 (KR) 10-2009-0076057

(51) Int. Cl. F16C 1/26

(52) U.S. Cl. 74/502.5

(57) ABSTRACT

An apparatus for reducing noise of a shift cable, may include a stopper that is integrally formed with an inner cable of the shift cable, an anti-vibration member that is disposed around the inner cable and is spaced apart from the inner cable to selectively contact with the stopper, and a damper housing that retains the anti-vibration member and the stopper therein

### CROSS-REFERENCE TO RELATED APPLICATIONS

The present application claims priority to Korean Patent Application Number 10-2009-0076057 filed Aug. 18, 2009, the entire contents of which application is incorporated herein for all purposes by this reference.

### BACKGROUND OF THE INVENTION

1. Field of the Invention

The present invention relates to an apparatus for reducing noise of a shift cable, in detail, a technology that can be used to preventing gear whine noise of a vehicle equipped with an automatic transmission from being transmitted to the inside of the vehicle through a shift cable.

2. Description of Related Art

Transmissions of vehicles, both manual transmissions and automatic transmissions, are provided with a shift lever that is an operating unit in the vehicles and have a basic structure of transmitting an operational force of the shift lever to the transmissions through a shift cable.

Accordingly, gear whine noise generated by these transmissions can be transmitted to the inside of the vehicles through the shift cable and a method of mounting a mass damper on the shift cable is used to stop the noise in the related art.

However, the method of mounting a mass damper on the shift cable, as described above, has a problem that the weight is increased by the mass damper and considerable cost is required.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an apparatus for reducing noise of a shift cable that makes it possible to improve silence and riding comfort of a vehicle by effectively absorbing and stopping noise that is transmitted inside the vehicle through a shift cable from a transmission, without using an excessive heavy weight, such as a mass damper.

In an aspect of the present invention, the apparatus for reducing noise of a shift cable, may include a stopper that is integrally formed with an inner cable of the shift cable, an anti-vibration member that is disposed around the inner cable and is spaced apart from the inner cable to selectively contact with the stopper, and a damper housing that retains the anti-vibration member and the stopper therein.

The apparatus for reducing noise of a shift cable may further include two connecting pipes separated from each other by the anti-vibration member, wherein flanges having an increased outer diameter are formed at distal end portions of the two connecting pipes to face each other and disposed in the damper housing, and wherein at least one of the two connecting pipes is connected to an outer cable of the shift cable.

The stopper may have a shape of which the radius increases around the inner cable and the anti-vibration member has a small-diameter portion that decreases in radius between the two flanges to form an opening to receive the inner cable such that the small diameter portion of the anti-vibration is selectively in contact with the stopper between the two connecting pipes through the opening.

The stopper may be mounted on the inner cable to contact with the small-diameter portion of the anti-vibration member when the inner cable is pulled to D-range through the opening.

The stopper may decrease in diameter toward a shift level to form a conical shape and the small-diameter portion of the anti-vibration member may decrease in diameter to form a conical opening toward the shift level, corresponding to the conical shape of the stopper.

The damper housing may surround the two flanges to fill a gap between the two connecting pipes.

The two connecting pipes may have a T-shaped cross section with the flanges at the distal end portions and may be disposed such that the flanges of the two connecting pipes face each other, and the damper housing may be formed with a U-shape cross section around the flanges of the two connecting pipes.

The present invention makes it possible to improve silence and riding comfort of a vehicle by effectively absorbing and stopping noise that is transmitted inside the vehicle through a shift cable from a transmission, without using an excessive heavy weight, such as a mass damper.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating the structure of an apparatus for reducing noise of a shift cable according to an exemplary embodiment of the present invention.

FIG. 2 is a view showing another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

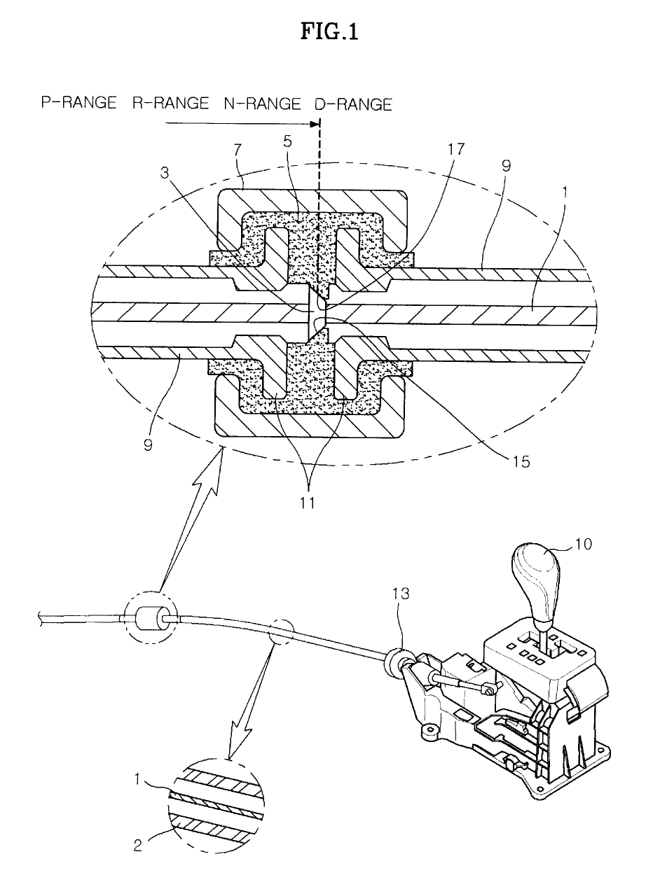

Referring to FIG. 1, an exemplary embodiment of the present invention includes: a stopper 3 that is integrally formed with an inner cable 1 of a shift cable; an anti-vibration member 5 that is disposed around inner cable 1 to be able to be spaced apart from inner cable 1 and contact with stopper 3, and absorbs and prevents vibration; and a damper housing 7 that covers and supports the outer side of anti-vibration member 5.

Two connecting pipes 9 separated from each other by anti-vibration member 5 are disposed in damper housing 7, flanges 11 having an increased outer diameter are formed at the ends of two connecting pipes 9 to face each other, and at least one of two connecting pipes 9 is connected to an outer cable 2 of the shift cable.

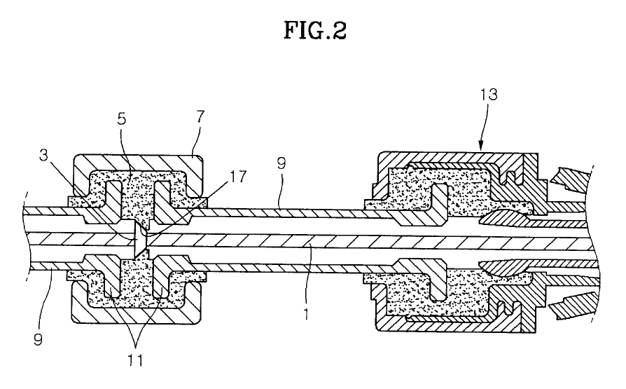

That is, connecting pipe 9 is connected to the outer cable 2 and acts as a substitute for the outer cable 2. When damper housing 7 and stopper 3 are disposed at the middle portion of the outer cable 2, both of two connecting pipes 9 are connected to the outer cable 2 by swaging etc., and as shown in FIG. 2, the shift level-sided connecting pipe 9 is connected to a mounting socket 13 mounted on a shift lever mounting bracket, in which connecting pipe 9 connected to mounting socket 13 is preferably configured such that both ends are symmetrical.

Stopper 3 has a shape of which the radius increases around inner cable 1 and anti-vibration member 5 has a small-diameter portion 15 that decreases in radius between two flanges 11 to be in contact with stopper 3 between two connecting pipes 9 and stopper 3.

Stopper 3 is mounted on inner cable 1 to contact with small-diameter portion 15 of anti-vibration member 5 when inner cable 1 is pulled to the D-range.

That is, stopper 3 is relatively less pulled while the shift lever is at P-, R-, and N-range, such that stopper 3 is not in contact with anti-vibration member 5, whereas stopper 3 is in contact with anti-vibration member 5 at the D-range where noise from the transmission is the largest. Accordingly, vibration or noise that is transmitted through inner cable 1 is absorbed and stopped by anti-vibration member 5, such that silence and riding comfort of the vehicle are improved.

Stopper 3 decreases in diameter toward the shift level 10 and small-diameter portion 15 of anti-vibration member 5 decreases in diameter of the opening toward the shift level 10 to form an opening 17, corresponding to shape of stopper 3.

Therefore, as inner cable 1 is pulled to the D-range through the opening 17, stopper 3 forms a contact surface as wide as possible with anti-vibration member 5, such that stable contact can be ensured.

Two connecting pipes 9 have a T-shaped cross section with flanges 11 at the ends and are disposed such that two flanges 11 face each other, and damper housing 7 is formed with the U-shape cross section around two connecting pipes 9 and surrounds two flanges 11 to prevent the gap between flanges 11 of two connecting pipes 9 from opening.

Meanwhile, anti-vibration member 5 may be made of rubber, and other than that, any material can be used if it can effectively absorb and stop vibration and maintain mechanical stable positional relationship of damper housing 7 and connecting pipes 9.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for reducing noise of a shift cable, comprising:
a stopper that is integrally formed with an inner cable of the shift cable;
an anti-vibration member that is disposed around the inner cable and is spaced apart from the inner cable to selectively contact with the stopper; and
a damper housing that retains the anti-vibration member and the stopper therein.

2. The apparatus for reducing noise of a shift cable as defined in claim 1, further comprising two connecting pipes separated from each other by the anti-vibration member,
wherein flanges having an increased outer diameter are formed at distal end portions of the two connecting pipes to face each other and disposed in the damper housing, and
wherein at least one of the two connecting pipes is connected to an outer cable of the shift cable.

3. The apparatus for reducing noise of a shift cable as defined in claim 2, wherein the stopper has a shape of which the radius increases around the inner cable and the anti-vibration member has a small-diameter portion that decreases in radius between the two flanges to form an opening to receive the inner cable such that the small diameter portion of the anti-vibration is selectively in contact with the stopper between the two connecting pipes through the opening.

4. The apparatus for reducing noise of a shift cable as defined in claim 3, wherein the stopper is mounted on the inner cable to contact with the small-diameter portion of the anti-vibration member when the inner cable is pulled to D-range through the opening.

5. The apparatus for reducing noise of a shift cable as defined in claim 3, wherein the stopper decreases in diameter toward a shift level to form a conical shape and the small-diameter portion of the anti-vibration member decreases in diameter to form a conical opening toward the shift level, corresponding to the conical shape of the stopper.

6. The apparatus for reducing noise of a shift cable as defined in claim 3, wherein the damper housing surrounds the two flanges to fill a gap between the two connecting pipes.

7. The apparatus for reducing noise of a shift cable as defined in claim 6, wherein the two connecting pipes have a T-shaped cross section with the flanges at the distal end portions and are disposed such that the flanges of the two connecting pipes face each other, and
the damper housing is formed with a U-shape cross section around the flanges of the two connecting pipes.
